(19) United States
(12) Patent Application Publication
(10) Pub. No.: US 2026/0241714 A1
(43) Pub. Date: Aug. 20, 2026

(54) RECORDING APPARATUS

(71) Applicant: SEIKO EPSON CORPORATION, TOKYO (JP)

(72) Inventors: Kazuki MOZUMI, MATSUMOTO-SHI (JP); Keisuke NIWA, CHINO-SHI (JP); Yuichi ARUGA, OKAYA-SHI (JP)

(21) Appl. No.: 19/544,023

(22) Filed: Feb. 19, 2026

(30) Foreign Application Priority Data
Feb. 19, 2025 (JP) 2025-024971

(51) Int. Cl. B41J 11/00; B41J 3/60; B41J 13/08; B41J 29/02

(52) U.S. Cl. CPC B41J 11/006; B41J 3/60; B41J 13/08; B41J 29/02

(57) ABSTRACT

A recording apparatus includes: a first conveyance path which faces a liquid ejection head; a second conveyance path is configured to curve a medium upward to flip the medium after the recording is performed on the medium by the liquid ejection head; a first unit configured to take a first state in which the second conveyance path is formed and a second state in which the second conveyance path is opened; and a second unit configured to detachably be attached to a apparatus main body to take an attached state and a detached state, and configured to form, in the attached state, the second conveyance path between the second unit and the first unit in the first state by being positioned between the liquid ejection head and the first unit in the first state, and to expose the first conveyance path in the detached state.

### CROSS-REFERENCE TO RELATED APPLICATIONS

The present application is based on, and claims priority from JP Application Serial Number 2025-024971, filed February 19, 2025, the disclosure of which is hereby incorporated by reference herein in its entirety.

### BACKGROUND

### 1. Technical Field

The present disclosure relates to a recording apparatus that performs recording on a medium.

### 2. Related Art

JP-A-2021-070556 discloses an image forming apparatus which includes a rotatable cover at a back surface of the apparatus, and a sheet conveyance path of which is exposed when the cover is opened to allow jam handling.

JP-A-2021-070556 is an example of the related art.

In an inkjet printer, when a recording head can easily be accessed when the cover is opened for the jam handling, there is a possibility that a user touches a head surface of the recording head to stain his or her hands and fingers with ink.

### SUMMARY

A recording apparatus according to the present disclosure for solving the problem described above includes: a liquid ejection head configured to perform recording by ejecting a liquid onto a medium; a first conveyance path which faces the liquid ejection head and through which the medium is conveyed; a second conveyance path which is coupled to the first conveyance path and is configured to curve the medium upward to flip the medium after the recording is performed on the medium by the liquid ejection head; an apparatus main body including the liquid ejection head, the first conveyance path, and the second conveyance path; a first unit configured to take a first state in which the second conveyance path is formed and a second state in which the second conveyance path is opened; and a second unit configured to detachably be attached to the apparatus main body to take an attached state and a detached state, and configured to form, in the attached state, the second conveyance path between the second unit and the first unit in the first state by being positioned between the liquid ejection head and the first unit in the first state, and to expose the first conveyance path in the detached state.

### BRIEF DESCRIPTION OF THE DRAWINGS

FIG. 1 is a diagram showing an entire medium conveyance path in a printer.

FIG. 2 is a diagram showing an operation of wiping a head surface of a line head with a wiper.

FIG. 3 is a cross-sectional view of an apparatus in a state in which both a first unit and a second unit are attached.

FIG. 4 is a cross-sectional view of the apparatus in a state in which the first unit is removed and the second unit is attached.

FIG. 5 is a cross-sectional view of the apparatus in a state in which both the first unit and the second unit are removed.

FIG. 6 is a cross-sectional view of the apparatus in a state in which both the first unit and the second unit are attached.

FIG. 7 is a diagram showing an attachment structure of a detection unit.

FIG. 8 is a cross-sectional view of the apparatus showing a state in which the second unit is removed to thereby hinder attachment of the first unit.

FIG. 9 is a diagram showing a posture of a lever in a state in which the second unit is removed.

FIG. 10 is a diagram showing the posture of the lever in the process of attaching the second unit.

FIG. 11 is a diagram showing the posture of the lever in a state in which the second unit is attached.

FIG. 12 is a side view of the apparatus in the state in which both the first unit and the second unit are attached.

FIG. 13 is a side view of the apparatus in the state in which the first unit is removed and the second unit is attached.

FIG. 14 is a perspective view of the second unit.

FIG. 15 is a diagram showing a configuration of separating a medium from a path forming surface of the second unit.

### DESCRIPTION OF EMBODIMENTS

The present disclosure will schematically be described below.

A recording apparatus according to a first aspect includes: a liquid ejection head configured to perform recording by ejecting a liquid onto a medium; a first conveyance path which faces the liquid ejection head and through which the medium is conveyed; a second conveyance path which is coupled to the first conveyance path and is configured to curve the medium upward to flip the medium after the recording is performed on the medium by the liquid ejection head; an apparatus main body including the liquid ejection head, the first conveyance path, and the second conveyance path; a first unit configured to take a first state in which the second conveyance path is formed and a second state in which the second conveyance path is opened; and a second unit configured to detachably be attached to the apparatus main body to take an attached state and a detached state, and configured to form, in the attached state, the second conveyance path between the second unit and the first unit in the first state by being positioned between the liquid ejection head and the first unit in the first state, and to expose the first conveyance path in the detached state.

According to the present aspect, since the second conveyance path is opened by setting the first unit to the second state, it is possible to remove the jammed medium. Here, even when the first unit is in the second state, since the second unit is attached to the apparatus main body, it is possible to prevent access to the liquid ejection head, and it is possible to prevent a user from inadvertently touching the liquid ejection head to thereby stain hands and fingers.

Note that, for example, a medium small in size and jammed before the leading end enters the second conveyance path can be exceptionally removed by detaching the second unit.

A second aspect is an aspect according to the first aspect, and further includes: a feeding path through which the medium is fed to the first conveyance path; and a third conveyance path configured to be located below the first conveyance path, receive the medium reversely fed through the second conveyance path, and guide the medium to the feeding path, wherein the first unit forms the third conveyance path in the first state, and opens the third conveyance path in the second state.

According to the present aspect, since the third conveyance path is opened by setting the first unit to the second state, it is possible to remove the jammed medium. Further, similarly to the above, even when the first unit is in the second state, since the second unit is attached to the apparatus main body, it is possible to prevent access to the liquid ejection head, and it is possible to prevent the user from inadvertently touching the liquid ejection head to thereby stain the hands and fingers.

A third aspect is an aspect according to the second aspect, and further includes a restriction member configured to retract from an occupied area by the first unit when the second unit is in the attached state, and restrict a change of the first unit to the first state by advancing to the occupied area by the first unit when the second unit is in the detached state.

According to the present aspect, due to the restriction member, it is possible to prevent the first unit from becoming in the first state while the second unit is kept in the detached state.

Note that this aspect may be dependent from not only the second aspect but also the first aspect.

A fourth aspect is an aspect according to the third aspect, wherein the restriction member includes a first arm portion configured to rotate about a rotary shaft and configured to engage with the first unit, and a second arm portion configured to engage with the second unit, the first arm portion advances to the occupied area by the first unit when the second unit is in the detached state, and the first arm portion retracts from the occupied area by the first unit by the second arm portion engaging with the second unit when the second unit is in the attached state.

According to the present aspect, with a simple configuration including the first arm portion and the second arm portion, it is possible to prevent the first unit from becoming in the first state while the second unit is kept in the detached state.

A fifth aspect is an aspect according to the third or fourth aspect, and further includes a detection unit configured to detect that the first unit is in the first state.

According to the present aspect, the detection unit can detect that the first unit is in the first state. Here, since the first unit cannot be switched to the first state due to the restriction member unless the second unit is attached, detection by the detection unit of the fact that the first unit is in the first state indicates the fact that the second unit is attached. That is, the detection unit can detect the attachment of not only the first unit but also the second unit, and a dedicated configuration for detecting an attachment state of the second unit is unnecessary, and thus, an increase in cost can be suppressed.

A sixth aspect is an aspect according to the second aspect, and further includes a conveyance roller pair configured to convey the medium downstream of the liquid ejection head in the first conveyance path, wherein the conveyance roller pair includes a first roller and a second roller that is located above the first roller and is supported by the second unit, the second unit is configured to switch between a nip state in which the medium is nipped between the first roller and the second roller and a nip release state in which the second roller is separated from the first roller by swinging about a pivot in the attached state, and the second unit is configured to engage with the first unit, take the nip state by receiving external force from the first unit when the first unit is in the first state, and take the nip release state when the first unit is in the second state.

According to the present aspect, when the first unit is in the second state, not only the second conveyance path is opened, but also the second unit is switched from the nip state to the nip release state, and thus the medium is less likely to be restrained by the conveyance roller pair when the jammed medium is removed, and the jammed medium can be easily removed.

Note that the present aspect may be dependent from not only the second aspect but also any one of the first aspect, and the third to fifth aspects.

A seventh aspect is an aspect according to the second aspect, wherein the second unit includes a recessed portion on a path forming surface that forms the second conveyance path, and the recessed portion is disposed at a position through which an end portion in a width direction of the medium passes defining the width direction as a direction crossing a conveyance direction of the medium.

When the medium adheres to the path forming surface, it is difficult to remove the medium, but according to the present aspect, it is possible to insert the hands and fingers of the user due to the recessed portion, and it is possible to easily remove the medium.

Note that the present aspect may be dependent from not only the second aspect but also any one of the first aspect, and the third to sixth aspects.

Hereinafter, the present disclosure will be specifically described.

An inkjet printer 1 is described below as an example of a recording apparatus that performs recording on a medium. The inkjet printer 1 is hereinafter simply referred to as a printer 1.

Note that an X-Y-Z coordinate system illustrated in the drawings is an orthogonal coordinate system, wherein arrow directions are positive (+) directions, and opposite directions to the positive directions are negative (-) directions. An X-axis direction is an apparatus width direction which corresponds to a width direction crossing a conveyance direction of a medium on which recording is performed. When viewed from an operator of the printer 1, a +X direction corresponds to the left side and a -X direction corresponds to the right side. In some cases, the X-axis direction is referred to as a medium width direction or simply referred to as the width direction.

A Y-axis direction is an apparatus depth direction and is a direction along a medium conveyance direction during recording. A +Y direction is a direction from a back surface toward a front surface of the apparatus and a -Y direction is a direction from the front surface toward the back surface of the apparatus. In the present embodiment, out of side surfaces constituting the circumference of the printer 1, a side surface at the +Y direction side corresponds to the front surface of the apparatus and a side surface at the -Y direction side corresponds to the back surface of the apparatus.

A Z-axis direction is a direction along a vertical direction and is an apparatus height direction. A +Z direction is a vertically upward direction, and a -Z direction is a vertically downward direction.

Note that, in the following, in some cases, a direction in which a medium is conveyed is referred to as "downstream" and a direction opposite to that direction is referred to as "upstream".

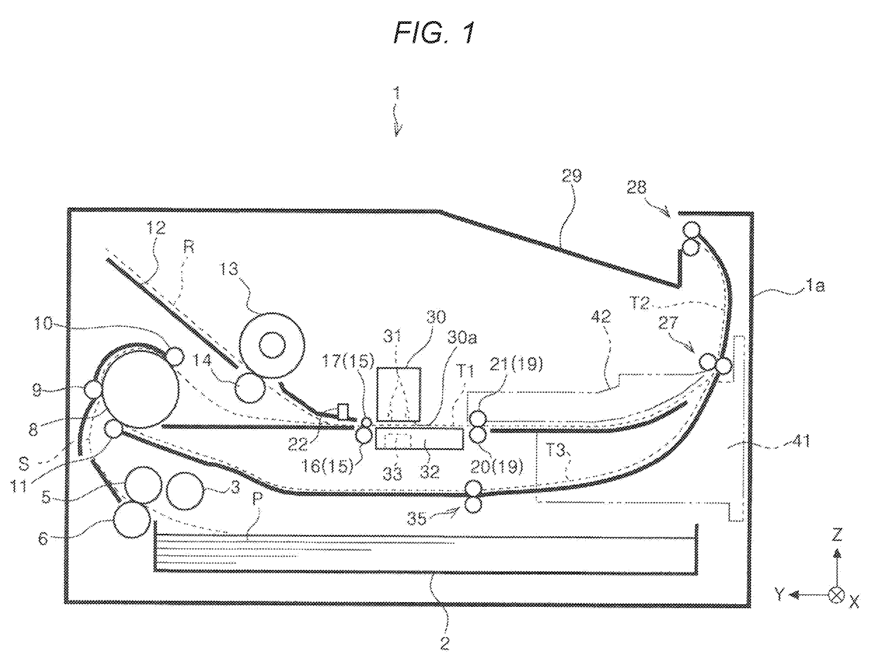

A medium conveyance path in the printer 1 will be described below with reference to FIG. 1. In FIG. 1, the medium conveyance path is indicated by a broken line.

A reference symbol S denotes a feeding path for feeding the medium from a medium storage cassette 2, and is a path from the medium storage cassette 2 to a first conveyance roller pair 15 via a flipping roller 8 in the present embodiment.

A reference symbol T1 denotes a first conveyance path which faces a line head 30, which is an example of a liquid ejection head described later, and through which the medium is conveyed. In the present embodiment, the first conveyance path T1 is a path from the first conveyance roller pair 15 to a second conveyance roller pair 19.

A reference symbol T2 denotes a second conveyance path which is coupled to the first conveyance path T1 to curve the medium upward and flip the medium after the line head 30 performs recording on the medium. In the present embodiment, the second conveyance path T2 is a path from the second conveyance roller pair 19 to a discharge roller pair 28.

A reference symbol T3 denotes a third conveyance path that is located below the first conveyance path T1, receives the medium reversely fed through the second conveyance path T2, and guides the medium to the feeding path S. In the present embodiment, the third conveyance path T3 is a path from a third conveyance roller pair 27 described later to the feeding path S via a fourth conveyance roller pair 35.

The first conveyance path T1, the second conveyance path T2, the third conveyance path T3, and the line head 30 are disposed inside an apparatus main body 1a. The second conveyance path T2 is formed of a first unit 41 and a second unit 42 that are detachably attached to the apparatus main body 1a, and these units will be described later in detail.

Hereinafter, a configuration on the paths will be described in order from the feeding path S.

A reference symbol P denotes media stored in the medium storage cassette 2. An example of the media is recording paper. The medium storage cassette 2 is detachably attached to the apparatus main body 1a of the printer 1 from the apparatus front surface.

A pickup roller 3 driven by a motor (not illustrated) is disposed above the medium storage cassette 2. The pickup roller 3 is capable of advancing to and retracting from the media stored in the medium storage cassette 2 and rotates while being in contact with the media stored in the medium storage cassette 2 to feed the media from the medium storage cassette 2 in the +Y direction.

A feed roller 5 driven by a motor (not illustrated) and a separation roller 6, to which rotational torque is applied by a torque limiter (not illustrated), are disposed downstream with respect to the medium storage cassette 2. The media fed from the medium storage cassette 2 are nipped by the feed roller 5 and the separation roller 6 to be separated and the separated medium is further fed downstream.

The flipping roller 8 driven by a motor (not illustrated) is disposed downstream of the feed roller 5 and the separation roller 6. A first nip roller 9, a second nip roller 10, and a third nip roller 11 are disposed around the flipping roller 8. The medium fed through the feeding path S is nipped by the flipping roller 8 and the first nip roller 9, and is further nipped by the flipping roller 8 and the second nip roller 10 to be conveyed. The conveyance direction of the medium is reversed from the +Y direction to the -Y direction by the flipping roller 8, and the medium is conveyed downstream.

Further, the printer 1 includes a feeding path R for feeding the medium from the medium placing section 12 in addition to the feeding path S for feeding the medium from the medium storage cassette 2. The medium placing section 12 supports the medium in an inclining posture, and the medium thus supported is conveyed to the first conveyance roller pair 15 by a feed roller 13 driven by a motor (not illustrated). A reference symbol 14 denotes a separation roller to which rotational torque is applied by a torque limiter (not illustrated).

The first conveyance roller pair 15 including a driving roller 16 driven by a motor (not illustrated) and a driven roller 17 capable of rotating so as to follow the driving roller 16 is disposed downstream of the flipping roller 8. The driven roller 17 is pressed toward the driving roller 16 by a pressing member (not illustrated).

The line head 30 is an example of a liquid ejection head that ejects ink as an example of a liquid onto the medium to perform recording. The line head 30 is the liquid ejection head having a plurality of nozzles 31 which eject the ink and are arranged so as to cover the entire area in the medium width direction. The line head 30 is configured as the liquid ejection head long in the medium width direction and capable of performing recording in the entire area in the medium width direction without the movement in the medium width direction.

A reference symbol 30a denotes a head surface corresponding to a surface facing the medium. The head surface 30a can also be referred to as a liquid ejection surface or a nozzle surface. The head surface 30a is parallel to the medium conveyance direction, that is, the Y-axis direction at a position facing the line head 30. Further, the head surface 30a is parallel to an X-Y plane.

The printer 1 includes an ink container (not illustrated), and the ink to be ejected from the line head 30 is supplied from the ink container to the line head 30 via an ink tube (not illustrated).

Note that, instead of the line head 30, a recording head that performs recording on the medium while moving along the medium width direction may be adopted. Further, a device for performing recording on the medium is not limited to a system which performs recording on the medium by ejecting the ink and may be configured with a recording head of other systems such as a dot impact system.

An opposed portion 32 is disposed at a position opposed to the head surface 30a of the line head 30. The opposed portion may also be referred to as a platen. The opposed portion 32 related to the present embodiment includes an openable shutter (not illustrated), and supports the medium in a state in which the shutter is closed. A gap between the opposed portion 32 and the head surface 30a is hereinafter referred to as a platen gap.

A cap section 33 is disposed below the shutter (not illustrated), and can be opposed to the head surface 30a when the shutter opens. The line head 30 is disposed to be movable upward and downward with power of a motor (not illustrated). The cap section 33 can cover the head surface 30a when the line head 30 moves downward in a state in which the shutter is opened.

As described above, the line head 30 is disposed so as to be able to move along a direction in which the line head 30 move closer to and away from the opposed portion 32, that is, an adjustment direction of the platen gap due to the power of the motor (not illustrated). In the present embodiment, the adjustment direction of the platen gap is parallel to the Z-axis direction. Hereinafter, the movement of the line head 30 toward the +Z direction is referred to as "rising" and the movement of the line head 30 toward the -Z direction is referred to as "falling" in some cases.

Defining a position of the line head 30 when performing recording on plain paper as a first recording position, when recording is performed on special paper thicker than the plain paper, the line head 30 is positioned at a second recording position where the line head 30 is rising from the first recording position.

Further, a movement area of the line head 30 includes a jam handling position as a position where the line head 30 rises the farthest. When the line head 30 rises to the jam handling position, the platen gap becomes the widest. Accordingly, when a jam occurs, the medium thus jammed can be removed.

Further, the movement area of the line head 30 includes a cap position as a position where the cap section 33 described above covers the head surface 30a.

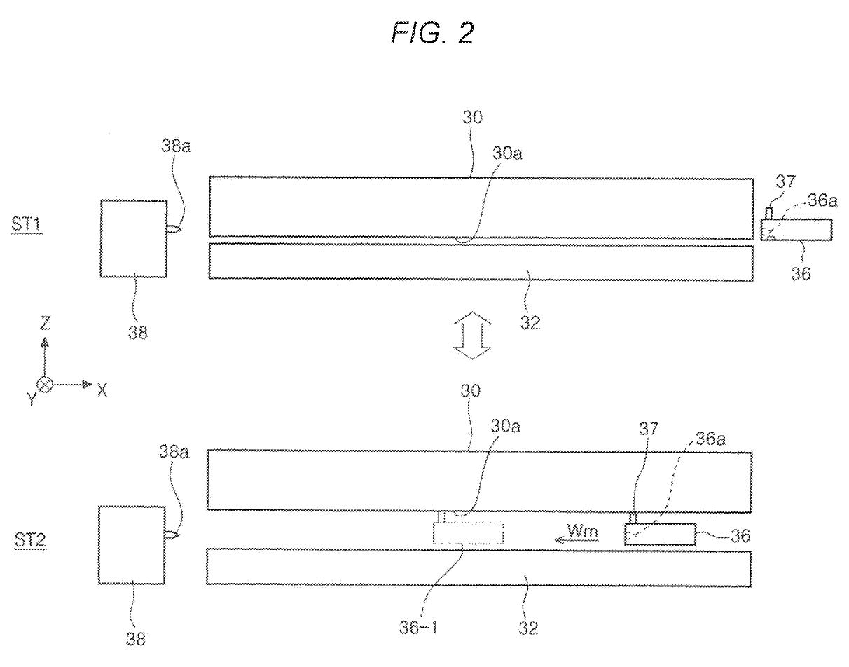

In addition, the movement area of the line head 30 includes a wiping position as a position where a wiper 37 (see FIG. 2) wipes the head surface 30a.

In the present embodiment, the aforementioned positions of the line head 30 are arranged toward the +Z direction in the order of the cap position, the first recording position, the second recording position, the wiping position, and the jam handling position.

Here, the wiper 37 will be described with reference to FIG. 2.

The printer 1 includes a wiper carriage 36 which is moved in the X-axis direction by a motor (not illustrated). In the present embodiment, a position of an end portion in the +X direction is defined as a home position of the wiper carriage 36.

The wiper carriage 36 is formed in a box shape with an upper portion opened, and is provided with the wiper 37. The wiper 37 is made of an elastic material such as rubber, and wipes the head surface 30a by the wiper carriage 36 moving in the medium width direction in a state of having elastic contact with the head surface 30a. The ink removed by wiping is retained in the wiper carriage 36.

A fitting hole 36a is disposed in an end portion in the -X direction of the wiper carriage 36. A check valve (not illustrated) is provided to the fitting hole 36a, and is configured to prevent the ink retained in the wiper carriage 36 from leaking.

An ink collection portion 38 is disposed on an end portion in the -X direction in a movement area of the wiper carriage 36. The ink collection portion 38 includes a suction portion 38a, and the suction portion 38a can be fitted into the fitting hole 36a of the wiper carriage 36. When the wiper carriage 36 is moved to the end portion in the -X direction, the suction portion 38a is fitted into the fitting hole 36a. When the suction portion 38a is fitted into the fitting hole 36a, the check valve described above opens. In this state, by a pump (not illustrated) provided to the ink collection portion 38 being driven, the ink retained in the wiper carriage 36 is suctioned.

A state ST1 in FIG. 2 shows a state where the line head 30 is located at a recording position. When the head surface 30a is wiped by the wiper 37 in this state, the line head 30 is raised to the wiping position as illustrated by a change from the state ST1 to a state ST2 in FIG. 2. Accordingly, a gap for the wiper carriage 36 to enter is formed between the line head 30 and the opposed portion 32, and the wiper 37 can come into contact with the head surface 30a.

By moving the wiper carriage 36 as indicated by an arrow Wm in this state, the wiper 37 wipes the head surface 30a.

Returning to FIG. 1, the second conveyance roller pair 19 including a driving roller 20 driven by a motor (not illustrated) and a driven roller 21 capable of rotating so as to follow the driving roller 20 is disposed downstream of the line head 30. The medium on which recording has been performed is conveyed downstream by the second conveyance roller pair 19.

The driven roller 21 is supported by the second unit 42 described later. The driving roller 20 is an example of a first roller, and the driven roller 21 is an example of a second roller located above the driving roller 20.

The third conveyance roller pair 27 is disposed downstream of the second conveyance roller pair 19, and further the discharge roller pair 28 is disposed downstream of the third conveyance roller pair 27. The medium on which recording has been performed is discharged to a discharge tray 29 by the discharge roller pair 28 in a state in which the most recent recording surface faces down.

When performing recording on both surfaces of the medium, the medium is fed to the third conveyance path T3 by the third conveyance roller pair 27 and the discharge roller pair 28 rotating reversely. The fourth conveyance roller pair 35 is disposed in the third conveyance path T3, and the medium fed into the third conveyance path T3 is fed between the flipping roller 8 and the third nip roller 11 by the fourth conveyance roller pair 35. Then, the medium enters the feeding path S and is fed toward the first conveyance roller pair 15 once again by the flipping roller 8. By providing such a third conveyance path T3, recording can be performed on both surfaces of the medium.

Subsequently, the first unit 41 and the second unit 42 which form the second conveyance path T2 will be described.

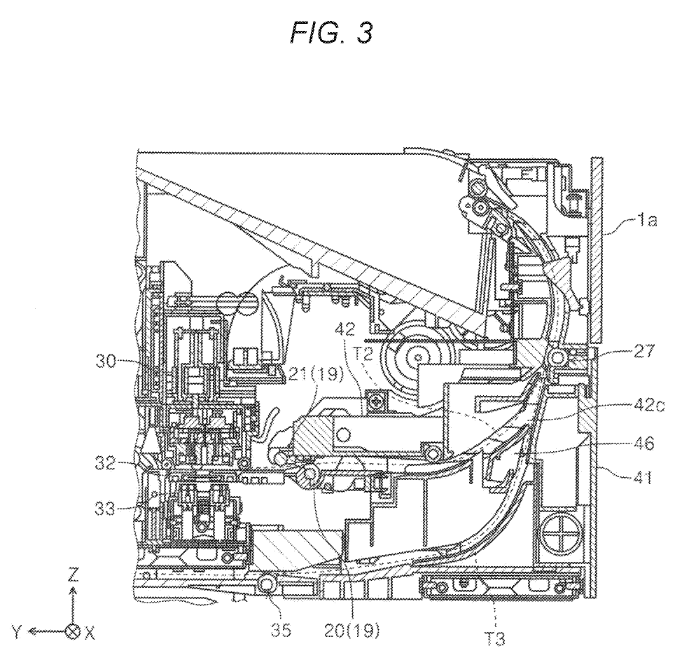

The first unit 41 and the second unit 42 are disposed so as to be detachable from the back surface side of the apparatus main body 1a. FIG. 3 illustrates a state in which both the first unit 41 and the second unit 42 are attached to the apparatus main body 1a. In this state, a part of a zone from the second conveyance roller pair 19 to the third conveyance roller pair 27 out of the second conveyance path T2 is formed between the first unit 41 and the second unit 42. The first unit 41 and the second unit 42 form a part of a curved zone in the second conveyance path T2.

The second unit 42 forms an upper part of the second conveyance path T2, and the first unit 41 forms a lower part of the second conveyance path T2.

In addition, a part of a zone upstream of the fourth conveyance roller pair 35 out of the third conveyance path T3 is formed inside the first unit 41.

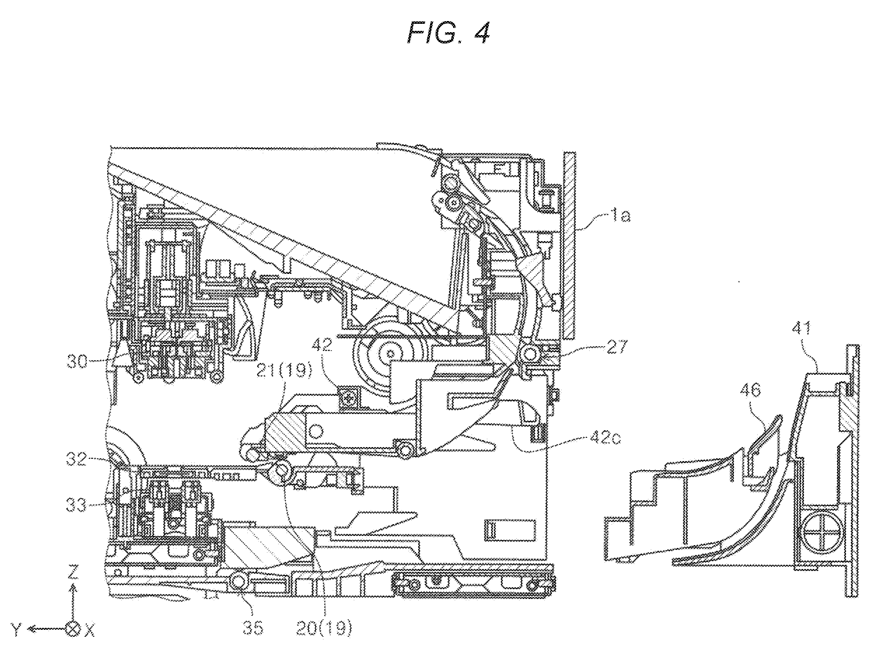

An attached state of the first unit 41 can be unlocked by operating an unlocking operation portion (not illustrated), and the first unit 41 can be detached in the -Y direction from the apparatus main body 1a. FIG. 4 illustrates a state in which the first unit 41 is detached from the apparatus main body 1a. Note that in FIG. 4, the second unit 42 is kept in the attached state. The attached state of the first unit 41 is an example of a first state in which the first unit 41 forms the second conveyance path T2, and the state in which the first unit 41 is detached is an example of a second state in which the first unit 41 opens the second conveyance path T2.

By detaching the first unit 41, a part of the second conveyance path T2 and a part of the third conveyance path T3 are exposed, and it becomes possible to remove the medium which is jammed, that is, to perform jam handling when the jam has occurred in the part of these paths.

Note that in the present specification, when it is expressed, in particular, that the first unit 41 is in the "attached state", it means a state in which the first unit 41 is completely attached. In the state where the first unit 41 is completely attached, the first unit 41 is locked by a lock device (not illustrated).

Then, since the second unit 42 is located between the first unit 41 in the attached state and the line head 30, the second unit 42 cannot be detached in the attached state of the first unit 41. Further, by detaching the first unit 41, the second unit 42 is exposed, and the second unit 42 can be detached. When the second unit 42 is detached, the second conveyance path T2 is further opened, the first conveyance path T1 becomes accessible, and the jam handling can be performed when the jam occurs in the first conveyance path T1.

Note that a device for locking the second unit 42 in the attached state is not provided in the present embodiment, but may be provided.

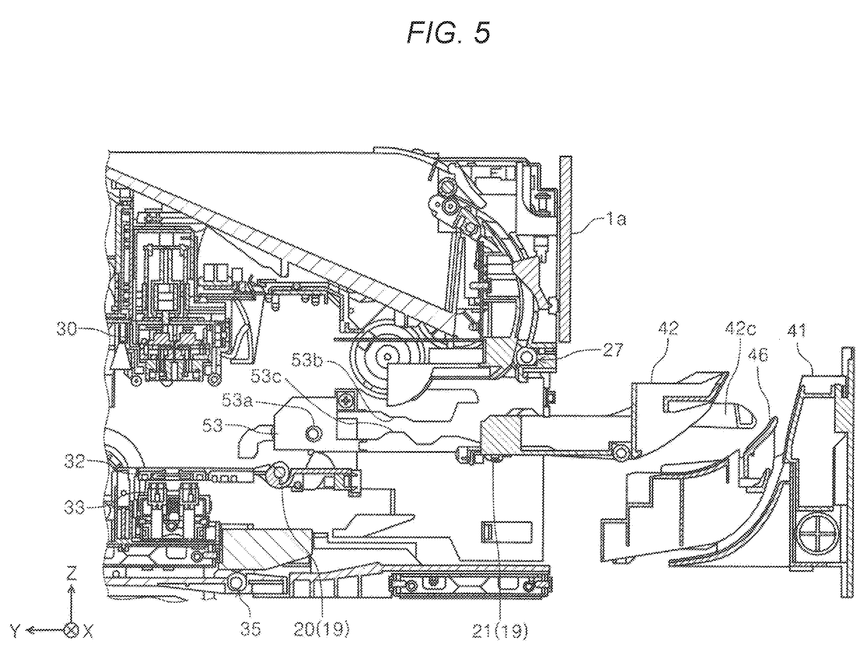

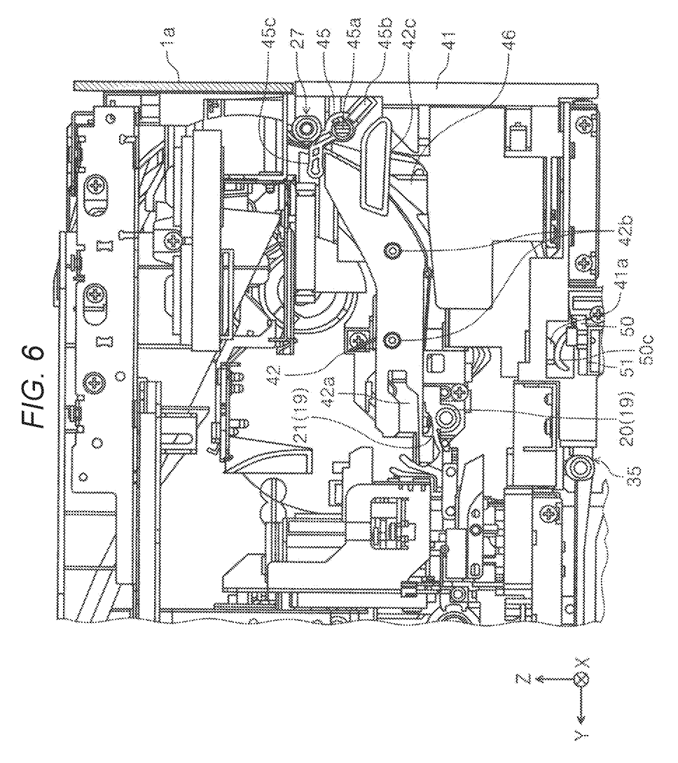

FIG. 5 illustrates a state where the second unit 42 is pulled out toward the -Y direction from the state in FIG. 4. As illustrated in FIGS. 6, 10, 11, 12, and 13, guide target portions 42b are formed on side surfaces in the X-axis direction of the second unit 42, that is, a side surface at the +X direction side and a side surface at the -X direction side. Note that FIGS. 3 to 5 illustrate a state in which the second unit 42 is cut along a Y-Z plane, but do not illustrate the guide target portions 42b. FIGS. 6, 10, 11, 12, and 13 are diagrams of side surfaces at the -X direction side of the first unit 41 and the second unit 42 viewed from the -X direction.

The plurality of guide target portions 42b is disposed at intervals along the Y-axis direction. Note that the plurality of guide target portions 42b is disposed similarly on the side surface at the +X direction side of the second unit 42.

In FIGS. 5 and 8 to 13, a reference symbol 53 denotes attachment portions for attaching the second unit 42. The attachment portions 53 are disposed at both sides of the second unit 42 across the second unit 42 in the X-axis direction. In the attachment portion 53, an upper guide portion 53b and a lower guide portion 53c are disposed at an interval in the vertical direction. The guide target portion 42b of the second unit 42 enters a space between the upper guide portion 53b and the lower guide portion 53c, whereby the second unit 42 is guided in the Y-axis direction.

A boss 53a protruding along the X-axis direction is provided to the attachment portion 53. As illustrated in FIG. 6, engagement grooves 42a are formed at both side surfaces in the X-axis direction of the second unit 42. Note that although FIG. 6 illustrates the engagement groove 42a formed at the side surface at the -X direction side of the second unit 42, the engagement groove 42a is also formed at the side surface at the +X direction side.

When the second unit 42 is attached to the attachment portion 53, the boss 53a enters the engagement groove 42a. Accordingly, the second unit 42 can swing in the Y-Z plane with the boss 53a as a pivot.

Pressing target portions 42c are formed at both side surfaces in the X-axis direction of the second unit 42. The pressing target portion 42c is formed so as to protrude toward the -Y direction. The first unit 41 is provided with a pressing portion 46. The pressing portion 46 defines a posture of the second unit 42 by pushing up the pressing target portion 42c of the second unit 42 in the state where the first unit 41 and the second unit 42 are attached. That is, as described above, the second unit 42 can swing around the boss 53a in the attached state, but when the first unit 41 is attached, the pressing portion 46 pushes up the pressing target portion 42c to thereby make the second unit 42 unable to swing, and thus, the posture of the second unit 42 is fixed.

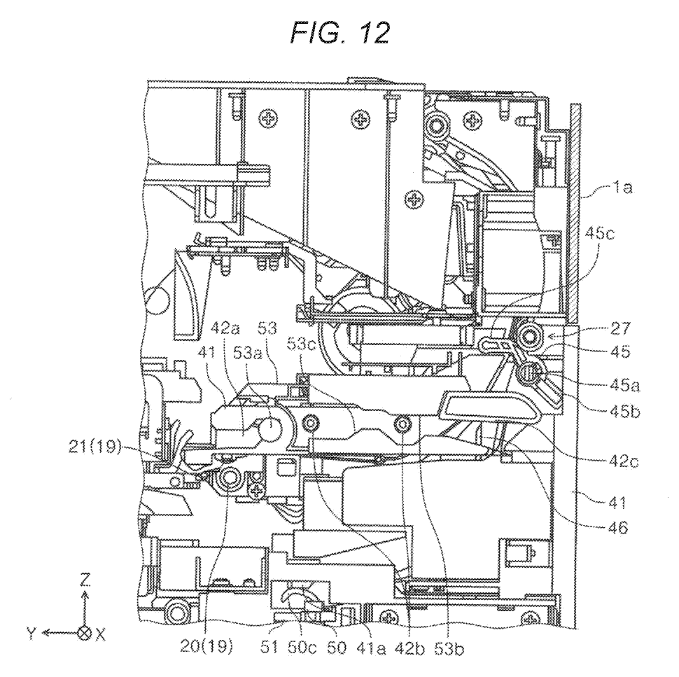

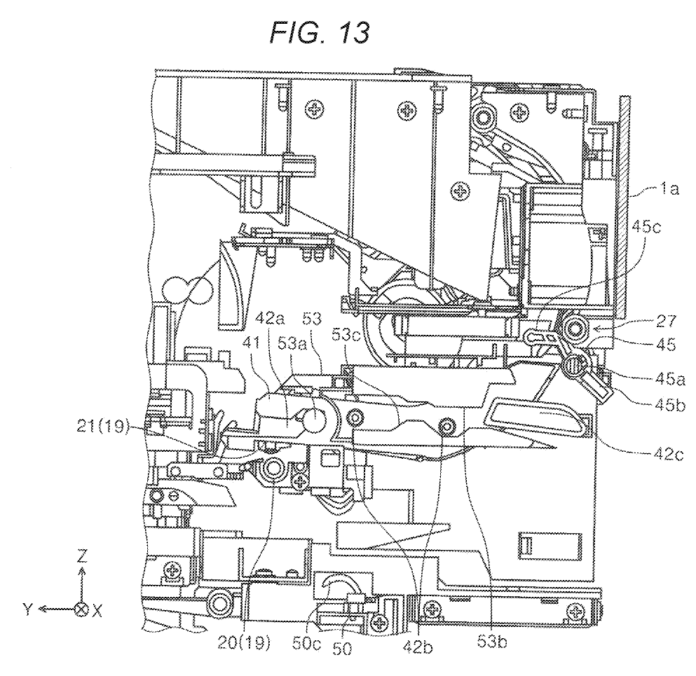

Here, the second unit 42 supports the driven roller 21 that constitutes the second conveyance roller pair 19. The driven roller 21 is located at the +Y direction side with respect to the boss 53a serving as the pivot of the second unit 42. Further, when the first unit 41 is detached, the second unit 42 is not restrained by the pressing portion 46, and thus an end portion at the -Y direction side, that is, the pressing target portion 42c swings downward, and thus, the driven roller 21 is displaced upward to be separated from the driving roller 20. This is represented by a change in state from FIG. 12 to FIG. 13.

Then, the apparatus main body 1a is provided with a lever 45 as illustrated in FIGS. 6 and 8 to 13. The lever 45 is disposed so as to be rotatable about a rotary shaft 45a in the Y-Z plane. The lever 45 includes a first arm portion 45b and a second arm portion 45c extending from the rotary shaft 45a. The first arm portion 45b is a region engageable with the first unit 41, and the second arm portion 45c is a region engageable with the second unit 42.

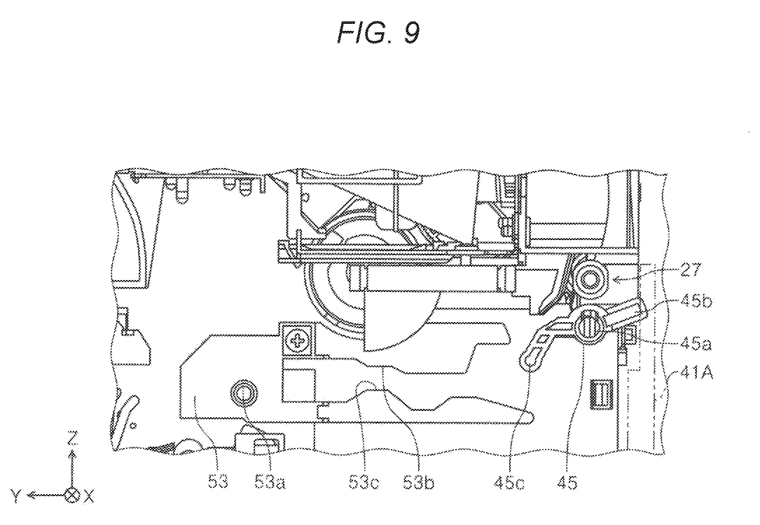

FIG. 9 illustrates a state in which the first unit 41 and the second unit 42 are not attached. In this state, the second arm portion 45c of the lever 45 enters an attachment path of the second unit 42. Note that in the present embodiment, the lever 45 takes the posture illustrated in FIG. 9 due to a weight balance between the first arm portion 45b and the second arm portion 45c, but may be pressed by a pressing member such as a coil spring so as to take the posture illustrated in FIG. 9.

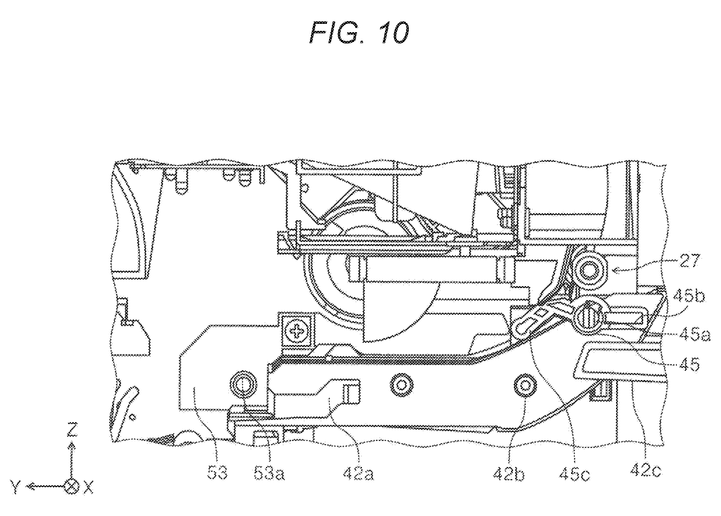

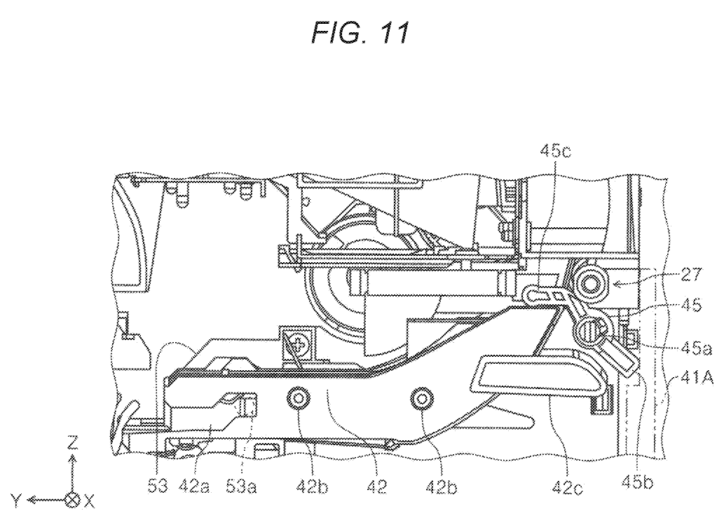

When the second unit 42 is attached in this state, an upper surface of the second unit 42 pushes up the second arm portion 45c so as to switch from the state in FIG. 9 to the state in FIG. 11 via the state in FIG. 10, whereby the lever 45 takes the posture illustrated in FIG. 11.

Here, in FIGS. 9 and 11, a reference symbol 41A denotes an occupied area by the first unit 41. In a state in which the second unit 42 is not attached, as illustrated in FIG. 9, the first arm portion 45b advances to the occupied area 41A by the first unit 41, which makes a state in which the first unit 41 cannot be completely attached. The occupied area 41A is an area occupied by the first unit 41 in the state where the first unit 41 is completely attached.

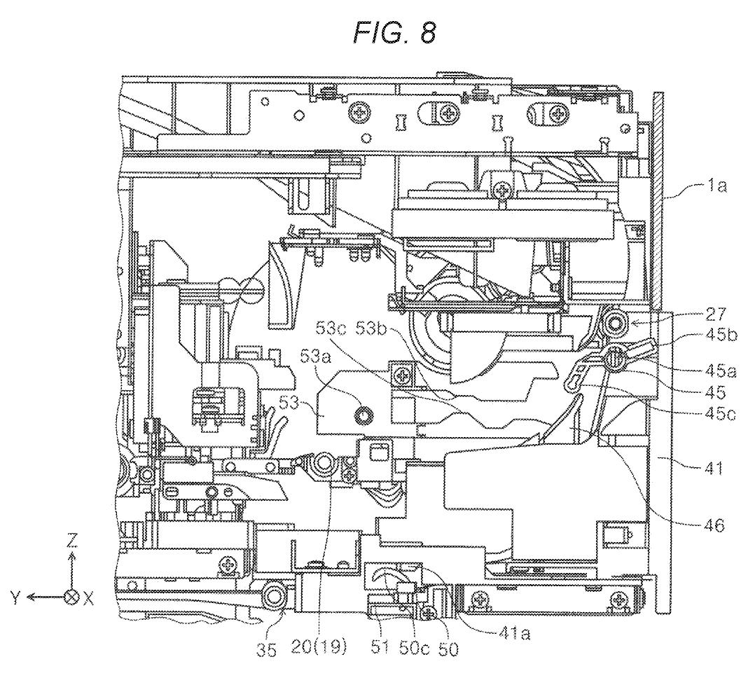

FIG. 8 illustrates a state in which complete attachment of the first unit 41 is hindered by the first arm portion 45b when the first unit 41 is to be attached in the state in which the second unit 42 is not attached.

On the other hand, when the second unit 42 is attached as illustrated in FIGS. 11 and 12, the first arm portion 45b is retracted from the occupied area 41A by the first unit 41, which makes it possible to completely attach the first unit 41.

Then, as illustrated in FIG. 6, a detection unit 50 is provided to the apparatus main body 1a. The detection unit 50 includes a detection lever 50c that is rotatable in the Y-Z plane. The detection lever 50c is pressed so as to protrude upward. As illustrated in FIG. 6, the first unit 41 includes a pressing portion 41a engageable with the detection lever 50c in the attached state. When the first unit 41 is completely attached, the detection lever 50c is pushed down by the pressing portion 41a. Accordingly, a control unit (not illustrated) of the printer 1 can detect that the first unit 41 is completely attached.

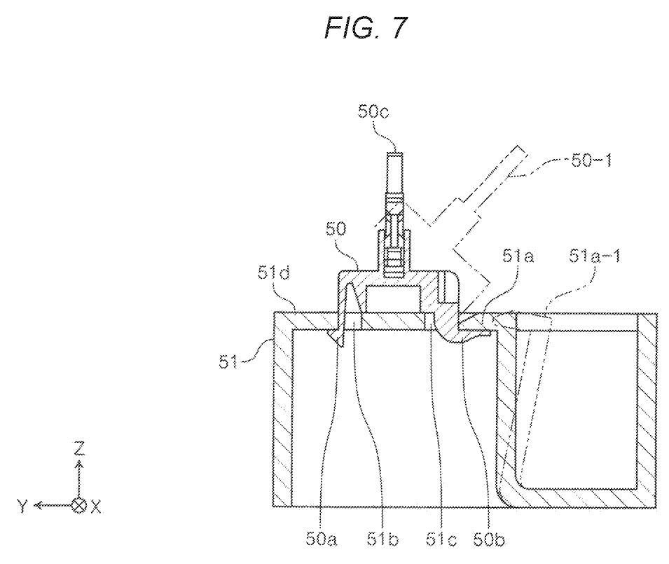

Note that the detection unit 50 is attached to an attachment portion 51 as illustrated in FIG. 7. The detection unit 50 is provided with a first locking portion 50a shaped like a hook and a second locking portion 50b shaped like a hook. The attachment portion 51 includes a plate portion 51d, and a first hole portion 51b and a second hole portion 51c are provided to the plate portion 51d. The first locking portion 50a of the detection unit 50 can be locked to a lower side of the plate portion 51d via the first hole portion 51b of the attachment portion 51. Further, the second locking portion 50b of the detection unit 50 can be locked to the lower side of the plate portion 51d via the second hole portion 51c of the attachment portion 51. In this way, the detection unit 50 becomes in the attached state.

Here, when there is adopted a configuration in which the plate portion 51d does not deform, when the detection unit 50 is attached, the second locking portion 50b is inserted into the second hole portion 51c while significantly inclining the detection unit 50 as indicated by a reference symbol 50-1, and then the first locking portion 50a is inserted into the first hole portion 51b. However, in this case, a space for significantly inclining the detection unit 50 is required, and it is necessary to ensure a large installation space for the detection unit 50, which may lead to an increase in size of the apparatus.

In order to prevent such a problem, a snap-fit portion 51a which can elastically be deformed is provided to the attachment portion 51. A part of the second hole portion 51c is formed with the snap-fit portion 51a. Since the snap-fit portion 51a is elastically deformable as indicated by a reference symbol 51a-1, when the detection unit 50 is attached, the detection unit 50 can be attached straight downward from above without inclining the detection unit 50. Accordingly, an increase in size of the apparatus can be suppressed.

As described above, the printer 1 includes the first unit 41 and the second unit 42 so as to detachably be attached to the apparatus main body 1a including the line head 30, the first conveyance path T1, and the second conveyance path T2. The first unit 41 can take the first state, that is, the attached state, in which the second conveyance path T2 is formed, and the second state, that is, a detached state, in which the second conveyance path T2 is opened.

The second unit 42 is a unit that is detachably attached to the apparatus main body 1a, forms the second conveyance path T2 between the second unit 42 and the first unit 41 in the attached state by being positioned between the line head 30 and the first unit 41 that is in the attached state, and exposes the first conveyance path T1 in the detached state.

Therefore, since the second conveyance path T2 is opened by detaching the first unit 41, it is possible to remove the medium jammed in the second conveyance path T2. Here, even when the first unit 41 is detached, since the second unit 42 is attached to the apparatus main body 1a, it is possible to prevent the access to the line head 30, and it is possible to prevent the user from inadvertently touching the line head 30 to stain the hands and fingers.

Note that, for example, a medium small in size and jammed before the leading end enters the second conveyance path T2 can be exceptionally removed by detaching the second unit 42.

Note that in the present embodiment, the first unit 41 is detachably attached to the apparatus main body 1a, but may be configured to be able to take the first state and the second state by sliding in the Y-axis direction with respect to the apparatus main body 1a. Further, alternatively, the first unit 41 may be configured to be rotatable with respect to the apparatus main body 1a so as to be able to take the first state and the second state.

Further, in the present embodiment, the third conveyance path T3 that receives the medium reversely fed through the second conveyance path T2 and guides the medium to the feeding path S is disposed below the first conveyance path T1. Further, the first unit 41 forms the third conveyance path T3 in the attached state, that is, the first state, and opens the third conveyance path T3 in the second state, that is, the detached state.

According to such a configuration, the third conveyance path T3 can be opened, and the medium jammed in the third conveyance path T3 can be removed. Further, similarly to the above, even when the first unit 41 is in the second state, that is, the detached state, since the second unit 42 is attached to the apparatus main body 1a, it is possible to prevent the access to the line head 30, and it is possible to prevent the user from inadvertently touching the line head 30 to stain the hands and fingers.

In addition, the printer 1 includes the lever 45 which is an example of a restriction member. The lever 45 retracts from the occupied area 41A by the first unit 41 when the second unit 42 is in the attached state (see FIG. 11), and advances to the occupied area 41A by the first unit 41 when the second unit 42 is in the detached state (see FIG. 9) to restrict a change of the first unit 41 to the attached state.

According to such a configuration, it is possible to prevent the first unit 41 from being in the first state, that is, the attached state while keeping the second unit 42 in the detached state. As a result, it is possible to prevent that the first unit 41 is attached while keeping the second unit 42 in the detached state and the medium is conveyed to cause a jam.

Further, the lever 45 includes the first arm portion 45b that is rotatable about the rotary shaft 45a and is engageable with the first unit 41 and the second arm portion 45c that is engageable with the second unit 42. In the state where the second unit 42 is detached, the first arm portion 45b advances to the occupied area 41A by the first unit 41. In the state where the second unit 42 is attached, the second arm portion 45c is engaged with the second unit 42, and thus, the first arm portion 45b is retracted from the occupied area 41A by the first unit 41.

According to such a configuration, with the simple configuration including the first arm portion 45b and the second arm portion 45c, it is possible to prevent the first unit 41 from being in the first state, that is, the attached state while the second unit 42 is kept in the detached state.

Further, the printer 1 includes the detection unit 50 that detects that the first unit 41 is in the first state, that is, the attached state. The detection unit 50 can detect that the first unit 41 is in the attached state. Here, since the first unit 41 cannot be switched to the attached state due to the lever 45 unless the second unit 42 is attached, detection by the detection unit 50 of the fact that the first unit 41 is in the attached state indicates the fact that the second unit 42 is attached. That is, the detection unit 50 can detect the attachment of not only the first unit 41 but also the second unit 42, and a dedicated configuration for detecting an attachment state of the second unit 42 is unnecessary, and thus, an increase in cost can be suppressed.

In the attached state, the second unit 42 can switch between a nip state (see FIG. 12) in which the medium can be nipped between the driving roller 20 and the driven roller 21 and a nip release state (see FIG. 13) in which the driven roller 21 is separated from the driving roller 20 using the boss 53a (see FIGS. 12 and 13) as the pivot. Further, the second unit 42 is engageable with the first unit 41, and takes the nip state by receiving external force from the first unit 41 when the first unit 41 is in the first state, that is, the attached state, and takes the nip release state when the first unit 41 is in the second state, that is, the detached state.

Accordingly, the medium is less likely to be restrained by the second conveyance roller pair 19 when removing the jammed medium, and the jammed medium can be easily removed.

Note that the second unit 42 swings by detaching the first unit 41, and the nip state of the second conveyance roller pair 19 is released in the present embodiment, but it is possible to adopt a configuration in which the nip state of the second conveyance roller pair 19 may be released without swinging the second unit 42.

In addition, by detaching the first unit 41, the nip state of not only the second conveyance roller pair 19 but also the third conveyance roller pair 27 and the fourth conveyance roller pair 35 may be released.

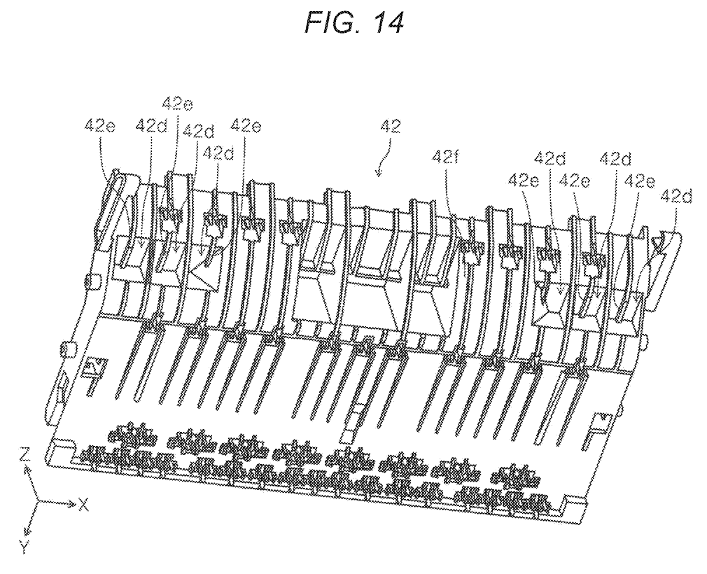

Further, in the present embodiment, as illustrated in FIG. 14, the second unit 42 includes recessed portions 42d on a path forming surface 42f that forms the second conveyance path T2. A plurality of recessed portions 42d is disposed in the X-axis direction, that is, in the width direction of the medium. The recessed portions 42d are disposed at positions through which an end portion in the width direction of the medium passes.

Here, when the medium adheres to the path forming surface 42f, it is difficult to remove the medium, but since the recessed portions 42d are disposed at the position through which the end portion in the width direction of the medium passes, it is possible to insert a hand and finger of the user due to the recessed portions 42d, and it is possible to easily remove the medium. Note that a rib 42e is formed inside the recessed portion 42d, and the rib 42e prevents a corner portion of the leading end of the medium from being caught by an edge of the recessed portion 42d.

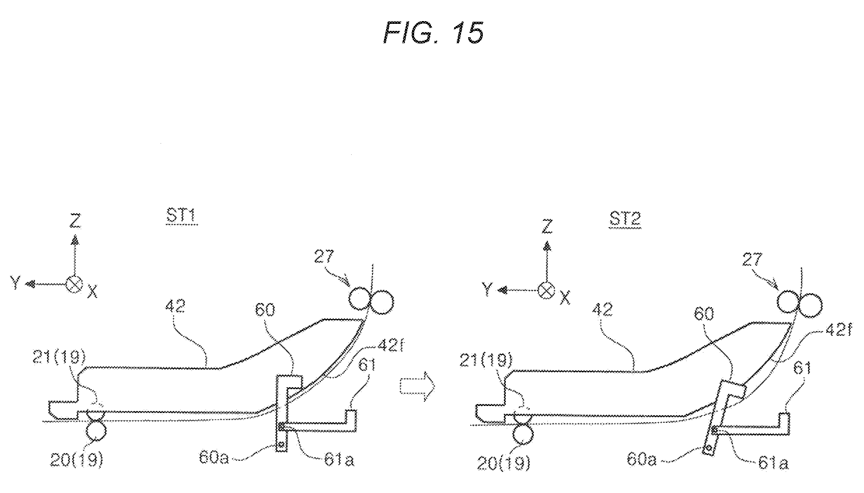

Note that it is possible to adopt a configuration in which the medium is separated from the path forming surface 42f by operating an operation portion 61 as illustrated in FIG. 15. In FIG. 15, a reference symbol 60 denotes a rotary member, and the rotary member 60 is disposed to be rotatable about a rotary shaft 60a. The operation portion 61 is coupled to the rotary member 60 via a coupling shaft 61a. The state ST1 in FIG. 15 is a state before the operation portion 61 is operated, and the rotary member 60 does not protrude from the path forming surface 42f. When sliding the operation portion 61 toward the -Y direction from this state, the rotary member 60 rotates and protrudes from the path forming surface 42f as represented by the change from the state ST1 to the state ST2. Accordingly, the medium is separated from the path forming surface 42f, the user's hands and fingers can be inserted, and the medium can be easily removed.

Note that a procedure of a jam handling operation in which the first unit 41 is first detached, and then the second unit 42 is detached when the jammed medium cannot be visually recognized on that occasion may be displayed by the control unit (not illustrated) of the printer 1 on an operation panel (not illustrated) of the printer 1 or a display unit of an information terminal capable of communicating with the printer 1.

Further, when it is detected that the first unit 41 is detached based on detection information of the detection unit 50, the control unit of the printer 1 moves the line head 30 to the jam handling position. On that occasion, the control unit may control the wiper carriage 36 to wipe the head surface 30a. As a result, it is possible to prevent the hands and fingers from being stained when the user touches the head surface 30a.

In addition, when the control unit detects that the first unit 41 is detached based on the detection information of the detection unit 50, the control unit may control the wiper carriage 36 to stop the wiper carriage 36 at a position facing the head surface 30a, particularly, a center position in the width direction of the line head 30 as indicated by a reference symbol 36-1 in FIG. 2. Accordingly, it is possible to prevent the medium from coming into contact with the head surface 30a when the jammed medium is pulled out.

Further, the present disclosure is not limited to the embodiments and modifications described above and various modifications can be made within the scope of the disclosure set forth in the appended claims, and it is needless to say that these modifications also fall within the scope of the present disclosure.

What is claimed is:

1. A recording apparatus comprising:
a liquid ejection head configured to perform recording by ejecting a liquid onto a medium;
a first conveyance path which faces the liquid ejection head and through which the medium is conveyed;
a second conveyance path which is coupled to the first conveyance path and is configured to curve the medium upward to flip the medium after the recording is performed on the medium by the liquid ejection head;
an apparatus main body including the liquid ejection head, the first conveyance path, and the second conveyance path;
a first unit configured to take a first state in which the second conveyance path is formed and a second state in which the second conveyance path is opened; and
a second unit configured to detachably be attached to the apparatus main body to take an attached state and a detached state, and configured to form, in the attached state, the second conveyance path between the second unit and the first unit in the first state by being positioned between the liquid ejection head and the first unit in the first state, and to expose the first conveyance path in the detached state.

2. The recording apparatus according to claim 1, further comprising:
a feeding path through which the medium is fed to the first conveyance path; and
a third conveyance path configured to be located below the first conveyance path, receive the medium reversely fed through the second conveyance path, and guide the medium to the feeding path, wherein
the first unit forms the third conveyance path in the first state, and opens the third conveyance path in the second state.

3. The recording apparatus according to claim 2, further comprising
a restriction member configured to retract from an occupied area by the first unit when the second unit is in the attached state, and restrict a change of the first unit to the first state by advancing to the occupied area by the first unit when the second unit is in the detached state.

4. The recording apparatus according to claim 3, wherein
the restriction member includes a first arm portion configured to rotate about a rotary shaft and configured to engage with the first unit, and a second arm portion configured to engage with the second unit,
the first arm portion advances to the occupied area by the first unit when the second unit is in the detached state, and
the first arm portion retracts from the occupied area by the first unit by the second arm portion engaging with the second unit when the second unit is in the attached state.

5. The recording apparatus according to claim 3, further comprising
a detection unit configured to detect that the first unit is in the first state.

6. The recording apparatus according to claim 2, further comprising
a conveyance roller pair configured to convey the medium downstream of the liquid ejection head in the first conveyance path, wherein
the conveyance roller pair includes a first roller and a second roller that is located above the first roller and is supported by the second unit,
the second unit is configured to switch between a nip state in which the medium is nipped between the first roller and the second roller and a nip release state in which the second roller is separated from the first roller by swinging about a pivot in the attached state, and
the second unit is configured to engage with the first unit, take the nip state by receiving external force from the first unit when the first unit is in the first state, and take the nip release state when the first unit is in the second state.

7. The recording apparatus according to claim 2, wherein
the second unit includes a recessed portion on a path forming surface that forms the second conveyance path, and
the recessed portion is disposed at a position through which an end portion in a width direction of the medium passes defining the width direction as a direction crossing a conveyance direction of the medium.
